(19) United States
(12) Patent Application Publication
(10) Pub. No.: US 2020/0158863 A1
(43) Pub. Date: May 21, 2020

(54) SENSOR SYSTEM FOR A VEHICLE AND METHOD FOR DETERMINING ASSESSMENT THREAT

(71) Applicants: Martin Hohla, Munich (DE); Clemens Rheinfelder, Wuppertal (DE)

(72) Inventors: Martin Hohla, Munich (DE); Clemens Rheinfelder, Wuppertal (DE)

(21) Appl. No.: 16/472,865

(22) PCT Filed: Dec. 22, 2017
(86) PCT No.: PCT/EP2017/084539

§ 371 Date: Jun. 22, 2019

(30) Foreign Application Priority Data
Dec. 23, 2016 (GB) 1622154.1

(51) Int. Cl. G01S 13/931; G01S 13/86; G01S 13/87

(52) U.S. Cl. CPC G01S 13/931; G01S 13/867; G01S 2013/93275; G01S 2013/93271; G01S 13/878

(57) ABSTRACT

A sensor system for a vehicle and a method for analysing the data from the sensor system is taught. The sensor system comprises at least two radar sensor arrays mounted on a portion of the vehicle and an analysis system receiving data from the at least two radar sensor arrays. The analysis system is adapted to generate an assessment threat from the data. The radar sensor arrays can be mounted in other components.

### FIELD OF THE INVENTION

The invention comprises a sensor system for a vehicle as well as a vehicle equipped with such a sensor system. The invention further provides for a method for analysing a plurality of sensor data and thus determining an assessment threat using the sensor system.

### BACKGROUND OF THE INVENTION

Sensor systems for vehicles are known in the art. These are particularly used for autonomous driving or semi-autonomous vehicles as well as for driver assist systems. The sensor systems comprise one or more sensors located on the body (chassis, fasciae or bumper, etc.) of the vehicle and can determine objects near the vehicle. Sensor data transmitted by the sensor can be processed by the sensor autonomously or is used by a unit to generate an assessment threat, such as whether a collision may take place with another vehicle, person or animal. The assessment threat can be used to slow, or completely stop the car or to steer automatically the vehicle away from the identified assessment threat.

For example, U.S. Pat. No. 6,151,539 (Volkswagen) teaches an autonomous vehicle and a method for controlling the autonomous vehicle. The autonomous vehicle includes an array of sensors, including at least one range sensor for detecting objects and at least one range sensor for detecting the condition features of the route.

A multi-sensor system is known from U.S. Pat. No. 7,102,496 (Yazaki North America) which discloses a sensor system comprising a plurality of external sensors. The system integrates data from the plurality of external sensors using a threat assessment subsystem to generate a threat assessment, such as but not limited to, a probable collision.

A further example of an autonomous vehicle with sensors is known from U.S. Pat. No. 5,307,419 (Honda) which discloses at least one image pickup unit which picks up the image of the moving road or a moving body. An image processing unit processes the data from the image pickup unit and can control the autonomous vehicles.

U.S. Pat. No. 5,467,072 (Piccard Enterprises) teaches a phased array based radar for a vehicular safety warning system for collision avoidance. The vehicular safety warning system includes a phased array based radar, a controlling processor, and a warning system that also provides a warning to the driver of the equipped vehicle as well as drivers of other, non-equipped automobiles involved in an unsafe driving condition. The phased array radar includes a flexible antenna array that may be mounted conformally on existing automobiles without detracting from their design curvature. In one embodiment described in the patent, a pair of phased array radar antenna may be oriented towards opposing sides of an equipped automobile to provide warning surveillance of vehicles laterally approaching the equipped auto from the sides. In another embodiment, a phased array radar antenna is oriented to the rear of the equipped automobile to provide warning surveillance of vehicles following the equipped auto too closely, and for warning of unsafe lane changes.

A known issue with the radar-based vehicular safety warning system using conformally mounted phased array radar, such as that disclosed in US '072, is that the radiation emitted from the arrays is dependent on very much of the position of the radar and also on the paint coating.

The sensor systems with optical sensors, like cameras or lidar sensors, known in the prior art are generally able to sense moving objects in good weather conditions. However, under adverse environmental conditions the data obtained from the sensors may not be reliable. For example, an image sensor cannot detect objects on a foggy day or during a storm. It is also known that lidar sensors are susceptible to error readings under adverse environmental conditions, such as snow or harsh sunlight. Furthermore, sensors are sensitive to dirt on the lens.

Radars are used to locate objects during such foggy days or storms and are much more reliable. However, their accuracy is limited by the need to ensure that the radars are located in the same position on the body. The radars are often located underneath the wheel arches because this is a known position and it unlikely to be substantially displaced in a minor accident. This placement limits the field of view, the aperture of the radars and significantly introduces attenuation for the radiated and received signals and means that such radars are not able to accurately identify any objects around the vehicle.

In addition, over time, systems equipped with the radar sensors age and their performance degenerates. Similarly, for conformal integrated antennas, any change in the shape or form of the vehicular body, such as slight scrape, dent or even re-painting can lead to change in the performance of the radar sensors.

There is therefore a need to develop a surround sensor system which can generate assessment threats under adverse environmental conditions substantially 360 degrees around the vehicle, and which also takes into account ageing or deformation of the vehicular body.

### SUMMARY OF THE INVENTION

A sensor system for a vehicle is taught in this document. The sensor system comprises one or more radar sensor arrays mounted on a portion of the vehicle and an analysis system receiving data from the radar sensor array. The analysis system comprises a processor and a stored data set. The analysis system is adapted to receive radar data from the radar sensor arrays and to generate an assessment threat from the received radar data and the data set. The one or more radar sensor arrays can be mounted in or on components of a body of the vehicle. The radar sensor arrays can be mounted all around the body, thus providing up to 360° of environmental sensing coverage.

In a further aspect, at least one imaging sensor is additionally mounted on the vehicle. The image sensor can provide further information about potential assessment threats as well as improving calibration of the radar sensor arrays.

The at least one radar sensor array comprises a plurality of radar elements with a plurality of antenna elements. This improves the sensitivity of detection and increases the aperture as well as providing redundancy should one of the radar elements or the antenna elements fail. The plurality of radar elements is mounted in a strip or a matrix arrangement.

The document also describes a method for analysis of a plurality of sensor data to generate an assessment threat. The method comprises receiving the sensor data from at least one radar sensor array and processing the radar data using a processor and a stored data set to identify the one or more objects. The assessment threat based on the processed radar data is then generated.

The method may further comprise receiving image data from at least one image sensor and additionally using the image data to generate the assessment threat or calibrating the radar data by identifying a horizontal and vertical reference.

### DETAILED DESCRIPTION OF THE FIGURES

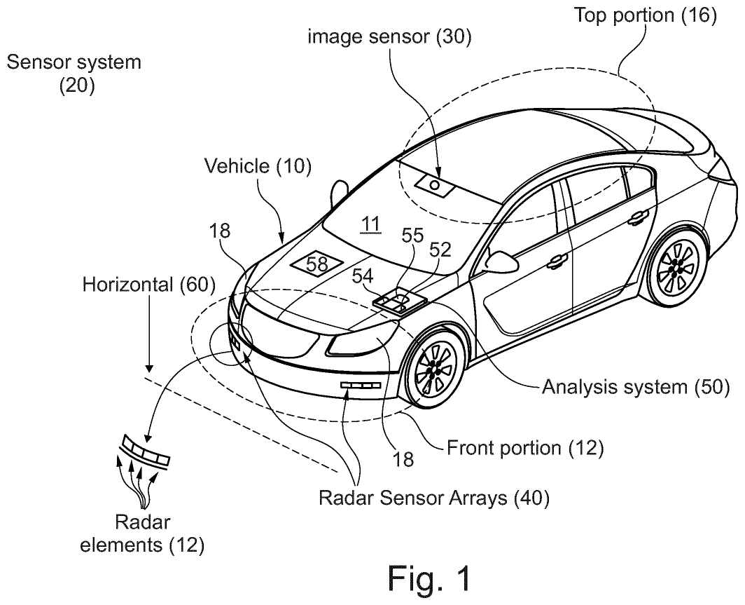

FIG. 1 shows a vehicle equipped with a sensor system according to one aspect of the invention.

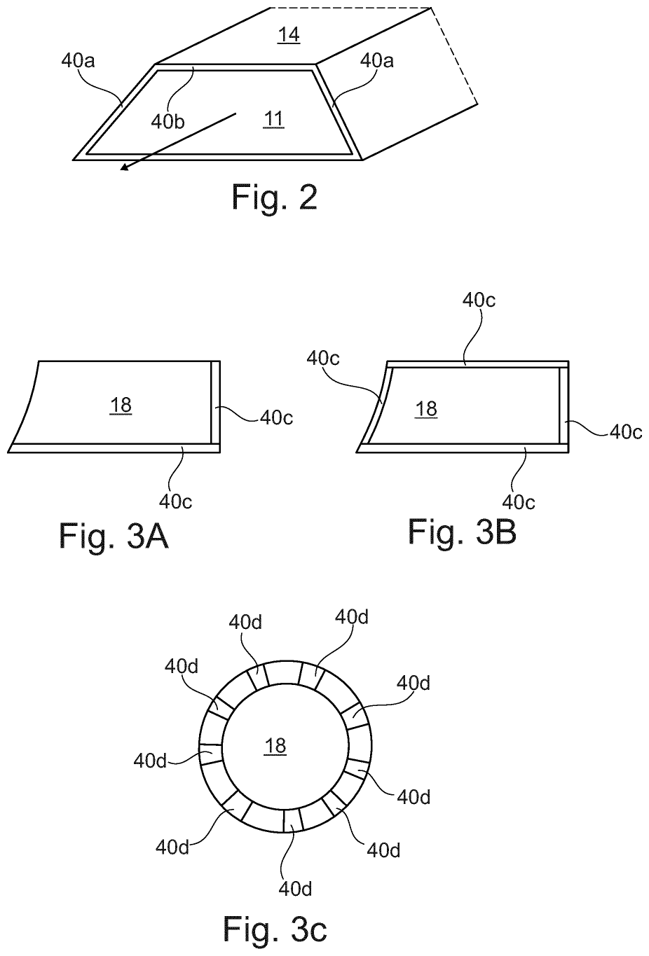

FIG. 2 shows an example of a radar sensor array incorporated about a windscreen.

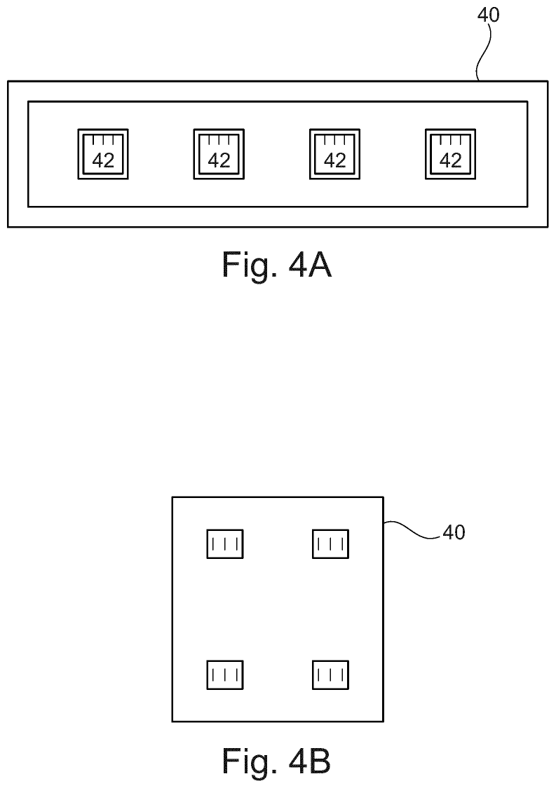

FIGS. 3A to 3C show example of radar sensor arrays incorporated in to a headlight.

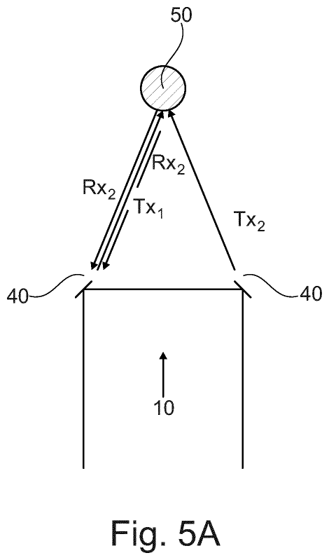

FIGS. 4A and 4B show a sensor array with a plurality of radar elements and a plurality of antenna elements suitable for mounting on a body of the vehicle.

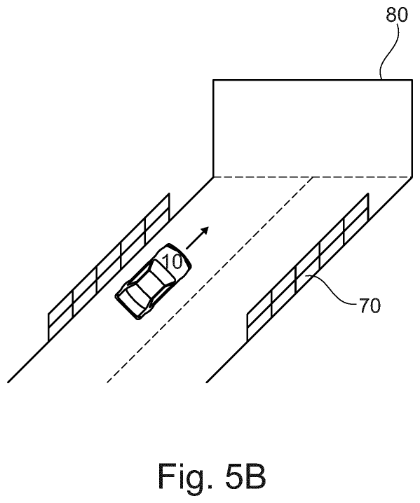

FIG. 5A shows a calibration system for a vehicle using an object.

FIG. 5B shows a calibration system for a moving vehicle.

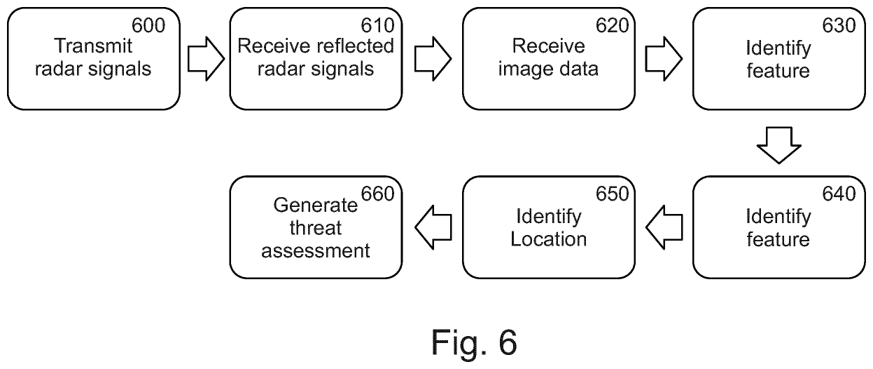

FIG. 6 shows a method for processing data from the sensor system to identify a threat.

### DETAILED DESCRIPTION OF THE INVENTION

FIG. 1 shows a vehicle 10 with a sensor system 20 according to one aspect of this description. The vehicle has a top position 14 which roughly corresponds to the roof of the vehicle 10, a windshield or windscreen 11, and a front portion 12 which roughly corresponds to the bonnet of the vehicle 10 in this figure. It will be appreciated that the vehicle 10 illustrated in FIG. 1 shows a typical car or automobile, such as a salon car, but this is merely illustrative of the invention. The vehicle 10 could be, but is not limited to, a pick-up truck, a bus, a heavy goods vehicle, an articulated lorry or motorbikes. It is equally possible that the sensor system 20 could be used on railways, guided buses, trams or trolleys and the sensor system 20 is not limited to the use on road vehicles.

The illustrated sensor system 20 has in one aspect of at least one image sensor 30 which is mounted on the vehicle 10 in the top position 14, but this location of the image sensor 30 is not limiting of the invention.

The sensor system has at least one radar sensor array 40 mounted in this FIG. 1 on a front portion 12 of the vehicle 10. In FIG. 1, two radar sensor arrays 40 are seen to mounted on each side of the front portion 12 on or behind the bumper or fender 13 and curve around the side of the vehicle 10. This curving around the side of the vehicle 10 enables the two radar sensor arrays 40 to transmit radar signals in the form of radio waves not merely in the direction of forward travel of the vehicle 10, but equally also to the side of the vehicle 10. The mounting of the two radar sensors 40 in such a manner together with synchronization enables the two radar sensors 40 to have effectively a large aperture.

In one aspect of the sensor system 20, the radar sensor arrays 40 are mounted conformally on the surface of the vehicle 10. This enables the transmitted radar signals to be transmitted more strongly and also removes risk of attenuation of the received radar signals due to components, such as fenders/bumpers, being located in front of the radar sensor arrays 40. The receiving sensitivity of the radar sensor arrays 40 is thus enhanced. In another aspect, the radar sensor arrays 40 are structurally integrated into the chassis of the vehicle 10.

It would be equally possible to have two or more radar sensors mounted additionally on the rear portion 16 of the vehicle 10 to transmit the radar signals behind the vehicle 10. Further radar sensors could be incorporated around the windscreen 11 as is shown, for example in FIG. 2. FIG. 2 shows radar sensors 40a at a left-hand side and a right-hand side of the windscreen 11 and a further radar sensor 40b at the top of the windscreen 11. The radar sensors 40a could be vertically mounted or slanted. It is also possible to incorporate radar sensors 40c in headlights 18. FIG. 3A shows two radar sensors 40c incorporated into a headlight 18. FIG. 3B shows three radar sensors 40c incorporated into the headlight 18 and FIG. 3C shows a round headlight 18, such as used on a motorbike, with a plurality of radar sensors 40d mounted around the circumference of the headlight 18. The radar sensor arrays 40 can be injection moulded into the components or applied using adhesives, for example, to the outside of the components of the vehicular body. It will be appreciated that the number of radar sensor arrays 40 is not limiting of the invention and indeed the invention would work with a single radar sensor array 40.

The two radar sensor arrays 40 are arranged as a plurality of radar elements 42 with a plurality of antenna elements, such as antennas with receivers and transmitters arranged in a strip-like manner on a flexible substrate, as shown in FIG. 4. FIG. 4A shows a one-dimension radar sensor array 40, but it will be appreciated that the radar sensor array 40 could be a two-dimensional array, such as shown in FIG. 4B. The flexible substrate enables the radar sensor array 40 to be integrated into the front portion 12 of the vehicle 10. The plurality of radar elements means that redundancy is built into the system. If any one of the plurality of radar elements fails, then the remaining ones of the radar elements can still function. The failed radar element can be replaced during a visit of the vehicle 10 to the repair shop. The radar sensor arrays 40 can be provided with a self-heating function to melt snow or ice on the radar sensor array 40 which would distort the signals.

The plurality of radar elements is calibrated by example cross-radiating and sensing. This is an operating mode in which one radar element in the radar sensor array 40 radiates and the other ones of the radar elements listen and are thereby calibrated to calculate for manufacturing intolerances and alignment on the vehicle body 10, etc. The calibration can be repeated at regular intervals to compensate for aging and failure of one or more of the radar elements. A calibration based on a hypothesis of known or long term observed objects, such as but not limited to landmarks, such as guard rails, tunnels or bridges and will be described in more detail below.

The vehicle has an analysis system 50 which is connected by wire or wirelessly to all of the radar sensor arrays 40 and the image sensor 30 and receives image data from the image sensor 30 and radar data from the radar sensor arrays 40. The analysis system 50 has a processor 52 for processing the radar data and the image data. The analysis system 50 has further a memory for storing a data set 54 which is used for calibration the radar data and the image data. The values in the data set 54 can be pre-stored and then adapted later during a calibration step as set out below.

It will be appreciated that there is a slight delay between the transmission of data from the radar sensor arrays 40 to the analysis system 50 and that this slight delay will depend on the length of the wire or the distance from the analysis system 50 to the transmitting or receiving one of the radar sensor arrays 40. This delay needs to be taken into account when analysing the data. The analysis system 50 is scalable and provides interfaces for other sensors, if required. The analysis system 50 is adapted to use the processor 52 and generate an assessment threat from the sensor data received from the radar sensor arrays 40 and, if present, the image sensor 30. It will be appreciated that the analysis system 50 may be connected to further sensors that are not illustrated on the figure. The analysis system 50 can use deep learning techniques to process the data from the radar sensor arrays 40 to predict performance

The analysis system 50 can include a master oscillator 55 or clock to synchronise all of the radar sensors 40 in the vehicle 10. This master oscillator 55 can also be used for calculating the slight delay between the radar sensor arrays 40, the image sensor 30, and the analysis system 50. Signals received by the radar sensor arrays 40 can be provided with an accurate time stamp for later processing by the analysis system 50.

It would also be possible with a wireless connection to retro-fit existing vehicles to enable them to use the system. The analysis system 50 could also be installed on a smartphone connected wirelessly to the retro-fitted radar sensor arrays 40, the image sensor 30 and other sensors.

Radar elements in the radar sensor arrays 40 operate as is known in the art. The radar elements generate radar signals in the form of radio waves at a specified frequency. The radio waves may strike an object in front of or to the side of the vehicle 10 and are then reflected. The reflected radio waves are detected by a detector as one of the radar elements and the data generated from the detection is transmitted to the analysis system 50. It would be possible for the radar sensor arrays 40 to further have their own processor for pre-processing the radar data from the radar sensor arrays 40.

The radar sensor arrays 40 can include a beam forming process to adapt the radar sensor data to the position and location of the radar sensors on the vehicle 10 by adjusting parameters, such as the delay, phase shift and amplitude, of the radar signals to and from the radar sensors 40 and ensuring that the transmitted and reflected radar signals between adjacent ones of the radar sensor arrays 40 on the same strip but also over different ones of the sensor arrays are coherent. The beam forming process enables the radar sensor arrays 40 to focus their radar beam on any potential or assessed threat or other objects. The beam forming process enables also the suppression of side lobes or optimization of the beam pattern from the radar signals, which might otherwise generate false positives, such as non-existent threats, from the sensor data. It would also be possible to use interference cancellation and beam-forming to “magnify” objects.

The calibration process will now be described with respect to FIG. 5A. FIG. 5A shows the vehicle 10 with two side or corner-mounted radar sensor arrays 40. An object 60 is positioned at a distance (x, y) from the vehicle 10. In a first step one or both of the radar sensor arrays 40 send a radar signal Tx1 and Tx2 which is reflected Rx1, Rx2 by the object 60 and then received by one or both of the radar sensor arrays 50. The received signals Rx1, Rx2 are transmitted to the analysis system 50. The position and distance (x,y) of the object 60 is known exactly and thus the analysis system 50 can determine the coefficients required for the beam forming process to adapt the antenna patterns and thus enable the object 60 to be accurately identified.

The calibration process can be repeated several times with different objects 60 in different positions to produce an individual data set 54 for the vehicle 10 relating to the different objects 60. This individual data set 54 is stored the memory in the analysis system 50.

The aspect shown in FIG. 5A is simplified as only two radar sensor arrays 40 are shown. In practice, there will be a plurality of radar sensor arrays 40 and thus the aperture for sensing is much greater than would be provided by the known devices. For example, if the radar sensor arrays 40 are provided so that the radar sensor arrays 40 are substantially positioned completely around the vehicle 10, then a 360° field of view is effectively obtained.

The analysis system 50 uses the data to generate a so-called assessment threat. The assessment threat is a threat which is determined or assessed by the analysis system 50 and is indicative, for example, of a possible collision with a stationary or moving object.

One issue with the radar sensor arrays 40 known in the art is their sensitivity to a change in their location on the body of the vehicle 10 and changes in their properties due to ageing. The system and method of this document enables dynamic changes in the calibration to be made.

Suppose now that the radar sensor array 40 on the bumper is moved due to the vehicle having been involved in an accident or gets a blow. The change in location of the radar sensor array 50 would mean that the assessment threat could be misidentified or mislocated. The analysis system 50 uses the data from the image sensor 30 in order to calibrate or cross-check the data from the radar sensor array 40. The image sensor 30 can, for example, view a horizontal object and compare this viewed horizontal object with the horizontal object calculated from radar data from the radar sensor array 40. The image sensor 30 may also be able to determine independently of the radar sensor array 40 the assessment threat and use its determination to calibrate, for plausibility or correct any errors in the radar sensor array 40. In inclement weather, such as rain or fog, it is possible that the image sensor 30 does not work particularly reliably. The analysis system 50 uses the radar data from the radar sensor array 40 together with previously calculated correction or correlation factors to determine the assessment threat.

The dynamic changes in the calibration can be made by making assumptions about the objects 60, such as landmarks, being detected by the analysis system 50. This is shown for example in FIG. 5B which shows the landmarks being guard rails 70 along the side of a highway on which the vehicle is travelling. FIG. 5B also shows that the vehicle 10 is about to enter a tunnel 80 or pass under a bridge 80, which are other types of landmarks.

The guard rails 70 have generally a known form and these will reflect the radar signals from the radar sensor arrays 40 in a known manner. The reflected signals from the radar sensor arrays 40 are analyses by the analysis system 50 and compared with expected values. Should the expected values deviate from the values received from the radar sensor arrays 40 by a small amount, corrections can be made to the data set 54 to take into account these deviations, which are probably due to ageing and/or deformation of the vehicle 10. Similarly, the structure of the bridge or tunnel 80 will be known (in this illustrated case two vertical sides and one horizontal top) and the reflected radar signals can be used to make any corrections to the data set 54.

It will be appreciated that the form of the guard rails 70 and the entry portal of the tunnel 80 or shape of the bridge 80 will depend on their location. The vehicle 10 can be provided with an accurate location sensor, based on the GPS or Galileo systems, and the analysis system 50 can use the location to determine the expected form of the guard rails, tunnel portal or bridge shape.

In another aspect of the invention, data from the image sensor 60 can be used to identify the landmarks and/or provide further data for calibration of the radar sensor arrays 40.

It will be appreciated that if the dynamic calibration suggests that the deviations are massive, then these deviations may be erroneous and incorrect. Such massive deviations will not be used for changing values in the data set 54. The calibration system can then either issue a warning that the analysis system 50 is not working correctly or ignore the apparent deviations.

FIG. 6 shows a method for determining the assessment threat. It will be appreciated that the example only uses the image sensor 30 (if present) and the radar sensor array 40 as shown in FIG. 1, but the principle can be applied to processing of data from other sensors mounted on the vehicle 10.

In a first step 600, the radar sensor arrays 40 transmit radar signals over an appropriate coverage area. It will be appreciated that different ones of the radar sensor arrays 40 are adaptive and may have different coverage areas, which can be dynamically adapted to the required field of view. These different coverage areas will, but do not have to, overlap with each other. For example, the radar sensor array 40 on the left-hand side of the vehicle 10 in FIG. 1 will cover the forward view and the left-hand side view of the vehicle 10. The right-hand one of the radar sensor arrays 40 will also cover the forward view, with some overlap, as well as the right-hand view (with no overlap with the left-hand radar sensor array).

The radar signals can be swept over the coverage area. In urban areas, it is preferable to sweep the coverage area near to the vehicle 10 more often that more distant coverage areas, as there is a greater risk of collision, for example, from nearby objects moving into the path of the moving vehicle. Objects that are further away are more likely to depart from the path of the moving vehicle in the time available and thus the risk is decreased.

On motorways or freeways (highways) with limited access, the opposite may be true. The risk of collision is greater from objects located further away because of the speed of movement of the vehicle 10. Furthermore, there are unlikely to be slow-moving objects on such highways.

Any reflected radar signals from one or more objects 60 is detected in step 610. The analysis system 50 can also receive in step 620 the image data from the at least one image sensor 30 (if present). The analysis system 50 in step 640 can use the radar data from the reflected radar signals and, if present, the image data to identify a feature, such as the object 60, and in step 650 the analysis system uses the radar data 50 to identify the position of the object 50. This is done by comparing the radar data with the data set 54. The position of the object 60 will be found by identifying a main lobe of the reflected radar signals. Since there will be radar data from more than one radar sensor array 40, then a process of triangulation can be carried out to identify the exact location of the object 60. The other information in the radar data will enable the type of object 60 to be identified.

In step 660 the assessment threat generated based on the radar data. Any moving objects 60 can be detected by continually monitoring the position of the moving objects 60 or/and by assessing a Doppler signal if available and making assumptions about the movement of the objects 60 to avoid collisions.

The analysis system 50 can be connected to a vehicle control system 58 which can override drivers' action and thus avoid a collision if necessary.

REFERENCE NUMERALS
10 Vehicle
11 Windshield or windscreen
12 Front Portion
13 Bumper or fender
14 Top Position
16 Rear Portion
18 Headlights
20 Sensor System
30 Image Sensor
40 Radar Sensors
50 Analysis System
55 Master Oscillators.
60 Object

1. A sensor system for a vehicle comprising:
at least one radar sensor arrays mounted on a portion of the vehicle;
an analysis system receiving radar data from the at least two radar sensor arrays, wherein the analysis system comprises a processor and a stored data set, and wherein the processor adapted to generate an assessment threat from the received radar data and the stored data set.

2. The sensor array of claim 1, further comprising at least one image sensor mounted on the vehicle.

3. The sensor system of claim 1, wherein the at least one radar sensor array comprises a plurality of antenna elements.

4. The sensor system of claim 2, wherein the plurality of radar elements are mounted in a strip.

5. The sensor system of claim 1, wherein the at least two radar sensor arrays are mounted further at least partially on a side portion of the vehicle.

6. The sensor system of claim 2, wherein the at least one image sensor is mounted on a top portion of the vehicle.

7. The sensor system of any of the above claims, wherein the processor is further adapted to update the stored data set.

8. A method for analysis of a plurality of sensor data to generate an assessment threat from one or more objects, wherein the sensor data comprises at least radar data and the method comprising:
receiving the radar data from at least one radar sensor array;
processing the radar data using a processor and a stored data set to identify the one or more objects; and
generating the assessment threat from the one or more objects based on the processed radar data.

9. The method of claim 8, further comprising receiving image data from at least one image sensor and additionally using the image data to generate the assessment threat.

10. The method of claim 8, further comprising updating the data set.

11. The method of claim 10, wherein the updating comprises identifying a known object and comparing received sensor data with expected values in the data set.

12. The method of claim 11, wherein the identifying comprises identifying at least one of a horizontal object and a vertical object from the image data.

13. A vehicle comprising the sensor system of claim 1.

14. The vehicle of claim 12, further comprising a vehicle control system for receiving the generated assessment threat and initiating vehicle actions in response to the generated assessment threat.

15. A sensor array comprising a plurality of radar antennas arranged in a strip-manner on a substrate and being mountable on a vehicle body.
